(19) United States
(12) Patent Application Publication
(10) Pub. No.: US 2015/0267948 A1
(43) Pub. Date: Sep. 24, 2015

(54) SYSTEM AND METHOD FOR OPERATING AN AIR CONDITIONING COMPRESSOR FROM ALTERNATIVE SOURCES

(71) Applicants: Richard D. Taylor, Kansas City, KS (US); Briar Steve, Kansas City, KS (US); Harris Paul, Belton, MO (US)

(72) Inventors: Richard D. Taylor, Kansas City, KS (US); Briar Steve, Kansas City, KS (US); Harris Paul, Belton, MO (US)

(21) Appl. No.: 14/223,501

(22) Filed: Mar. 24, 2014

(51) Int. Cl. F25B 31/02; F16H 7/20; F16H 7/08; F16H 7/02

(52) U.S. Cl. CPC F25B 31/02; F16H 7/02; F16H 7/20; F16H 7/0827; F16H 7/0848

(57) ABSTRACT

The disclosure depicts both a system for operating an air conditioning compressor from alternative sources as well as a method of operating an air conditioning compressor from alternative sources. Both the system and method require a primary source, an air conditioning compressor, and a motor generator. A respective shaft extends from each of these required components, and a respective pulley is mounted to each of the respective shafts, and a single belt engages each respective pulley.

### SUMMARY OF THE INVENTION

The invention is both a system for operating an air conditioning compressor from alternative sources as well as a method of operating an air conditioning compressor from alternative sources.

The Inventive System

The inventive system includes a primary source having a primary drive pulley coupled to a primary drive shaft. It also includes a sprag bearing having an inner race engaging the primary drive shaft and an outer race engaging the primary drive pulley. The sprag bearing enables rotation of the inner race relative the outer race in a single chosen direction of rotation.

The inventive system will also include a motor generator having a motor generator pulley coupled to a motor generator shaft. Further, it will also include an air conditioning compressor having and an air conditioning compressor pulley coupled to an air conditioning compressor shaft.

A belt engages each of the drive shaft pulley, the motor generator pulley, and the air conditioning compressor pulley. The sprag bearing prevents rotation of the primary drive shaft relative the primary drive shaft pulley when torque is imparted through the primary drive shaft. Conversely, the sprag bearing enables rotation of the primary drive shaft relative the primary drive shaft pulley when the primary drive pulley is rotated by torque transmitted to the primary drive pulley by the belt.

Optionally, the inventive system may include a drive housing adapted to allow the drive shaft to pass therethrough. The invention may include a reduced-diameter portion of the drive shaft positioned adjacent a terminal end of the primary drive shaft. When a shaft having a reduced-diameter portion is employed, the sprag bearing is coupled to the reduced diameter portion of the primary drive shaft. Preferably, the reduced diameter portion extends outwardly from the housing, where the sprag bearings are positioned and engage the primary source shaft.

The inventive system may also have a support bearing positioned on the primary drive shaft. Optionally, an inner portion of the support bearing engages the primary drive shaft and an outer portion of the support bearing engages within the drive housing.

In a preferred embodiment of the system, the a drive housing has an entrance opening and an exit opening. In this version of the system, the drive housing allows the primary drive shaft to pass therethrough. Additionally, drive gear may be positioned adjacent the entrance opening so that it could mesh with a bull gear of a motor.

In a preferred embodiment, a portion of the primary drive shaft that extends outwardly from the exit opening of the drive housing. In this embodiment, the inner race of the sprag bearing engages the portion of the primary drive shaft that extends outwardly from the exit opening of the drive housing. The system may also be configured so that the primary drive pulley has a belt-engaging portion and an elongate portion. In this preferred embodiment, the outer race of the sprag bearing engages an interior of the elongate portion. Additionally, drive housing may have a narrowed portion cooperatively formed to fit within and engage at least a portion of an interior of the primary drive pulley. The system may also include a switch to selectively activate the motor generator, as well as a clutch to selectively enable relative rotation of the air conditioning compressor shaft relative the air conditioning compressor pulley.

The Inventive Method

The invention is also a method of operating an air conditioning compressor from alternative sources. The inventive method includes the steps of providing a primary source, an air conditioning compressor, and a motor generator. The method also requires the steps of equipping the primary source with a primary drive pulley coupled to a primary drive shaft and equipping the motor generator with a motor generator pulley coupled to a motor generator shaft. Moreover, one must also equip the air conditioning compressor with an air conditioning compressor pulley coupled to an air conditioning compressor shaft.

The invention also requires the step of providing a sprag bearing having an inner race and an outer race, the sprag bearing enabling rotation of the inner race relative the outer race in a single chosen direction of rotation. Also, one must engag the inner race to the primary drive shaft, and engage the outer race to the primary drive pulley.

The inventive method also requires the step of engaging a belt with each of the drive shaft pulley, the motor generator pulley, and the air conditioning compressor pulley. Also, one must configure the sprag bearing to prevent rotation of the primary drive shaft relative the primary drive shaft pulley when torque is imparted through the primary drive shaft. Also, the method requires the step of configuring the sprag bearing to allow rotation of the primary drive shaft relative the primary drive shaft pulley when the primary drive pulley is rotated by torque transmitted to the primary drive pulley by the belt.

In an alternate preferred embodiment, the method may include the step of providing a drive housing adapted to allow the drive shaft to pass therethrough, and forming a reduced-diameter portion adjacent a terminus of the primary drive shaft. In this embodiment of the method, one couples the sprag bearing to the reduced diameter portion of the primary drive shaft. Optionally, one may couple the sprag bearings to a reduced diameter portion that extends outside the drive housing.

The inventive method may optionally include the step of mounting a support bearing to the primary drive shaft. Specifically, one may engage an inner portion of the support bearing with the primary drive shaft, and an outer portion of the support bearing with the drive housing.

Optionally, the method includes the additional steps of passing the primary drive shaft into an entrance opening of the drive housing and out from an exit opening of the drive housing, positioning a drive gear is adjacent the entrance opening, and, meshing the drive gear with a bull gear of a motor. In another embodiment, the method may include the additional steps of extending a portion of the primary drive shaft outwardly from the exit opening of the drive housing and engaging the inner race of the sprag bearing with the portion of the primary drive shaft that extends outwardly from the exit opening of the drive housing.

The primary drive pulley may be configured to include a belt-engaging portion and an elongate portion; wherein, the outer race of the sprag bearing engages an interior of the elongate portion. The drive housing may bear a narrowed portion cooperatively formed to fit within and engage at least a portion of an interior of the primary drive pulley.

The method enables one to deactivating the primary source, activate the motor generator to impart a rotating torque to the motor generator shaft; and thereby transmit the rotating torque to the air conditioning compressor.

### BRIEF DESCRIPTION OF THF DRAWINGS

FIG. 1 is a schematic diagram showing the basic components of the system and method, according to the principles of the invention.

FIG. 2 is a perspective schematic showing the components of the system.

FIG. 3 shows an exploded and perspective view that details the component parts of an auxiliary drive mechanism.

FIG. 4 shows a cross-sectional and view of the auxiliary drive portion of the inventive system.

FIG. 5 shows an isolated perspective view of the auxiliary drive mechanism.

### DETAILED DESCRIPTION OF THE PREFERRED EMBODIMENTS

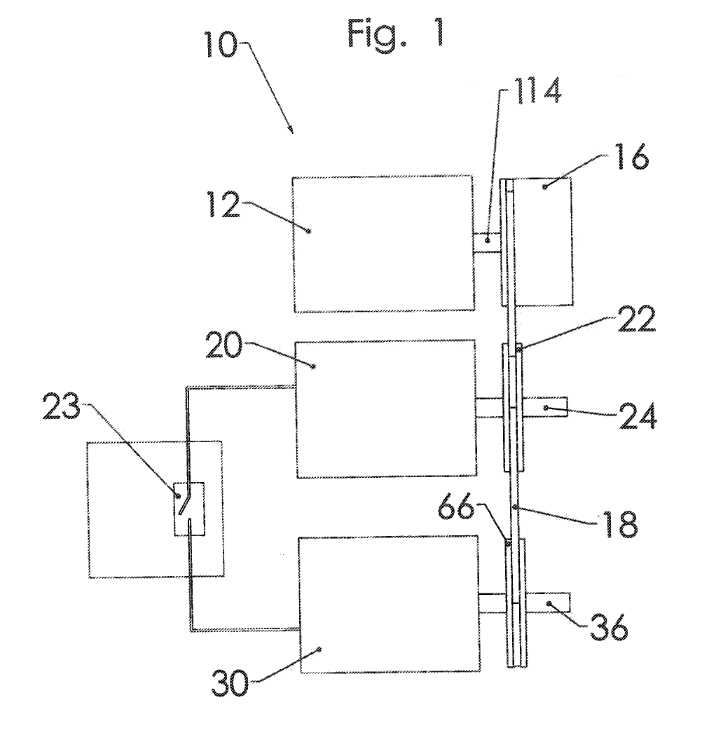

FIG. 1 shows a schematic diagram of the basic components of the invention.

The inventive system 10 includes a primary source 12, an air conditioning compressor 20, and a motor generator 30. Each of these components 12, 20, and 30 has a respective shaft and a pulley. Specifically, the air conditioning compressor pulley 22 is coupled to the air conditioning compressor shaft 24 extending from the air conditioning compressor 20. Further, a motor generator pulley 66 is coupled to a motor generator shaft 36 extending from the motor generator 30. In like manner, a primary source shaft 114 extends from the primary source 12, and terminates in a drive housing 16 that includes a pulley portion (shown in greater detail aft).

Still referring to FIG. 1, activation of the primary source 12 imparts torque through the primary source shaft 114 to a belt 18 that engages the respective pulleys 22, 66, thereby transmitting a rotating torque from the primary source shaft 114 to each of the air conditioning compressor pulley 22 and the motor generator pulley 66. Thus, when the primary source 12 is activated, torque originates with the primary source shaft 114, which then serves to drive the other elements of the system 10.

Still referring to FIG. 1, a clutch (not shown) may couple the air conditioner compressor pulley 22 to the air conditioning compressor shaft 24, thereby enabling the pulley 22 to rotate relative the shaft 24 when an operator does not wish to activate the air conditioning compressor 20.

The air conditioning compressor 20 is in electrical communication with the motor generator 30. Indeed, when the primary source 12 is not running, one may choose to run the air conditioning compressor 20 by imparting torque to its shaft 24 that originates from the motor generator 30. In contrast, when the primary source 12 is running, torque originates with the primary source 12, and this torque is transmitted to the air conditioning compressor 20 as well as the motor generator 30. While running, the motor generator 30 receives energy and transmits electrical charge to the battery pack 23.

A battery pack 23 includes a switch that is configured to selectively activate the motor generator 30, which can then create torque that could be transmitted through its motor generator shaft 36, into the motor generator pulley 66, passed along via belt 18, which can drive the air conditioning compressor pulley 22 coupled to the air conditioning compressor shaft 24. In turn, rotating the air conditioning compressor shaft 24 activates the air conditioning compressor 20, which provides cool air to the cabin of an automobile.

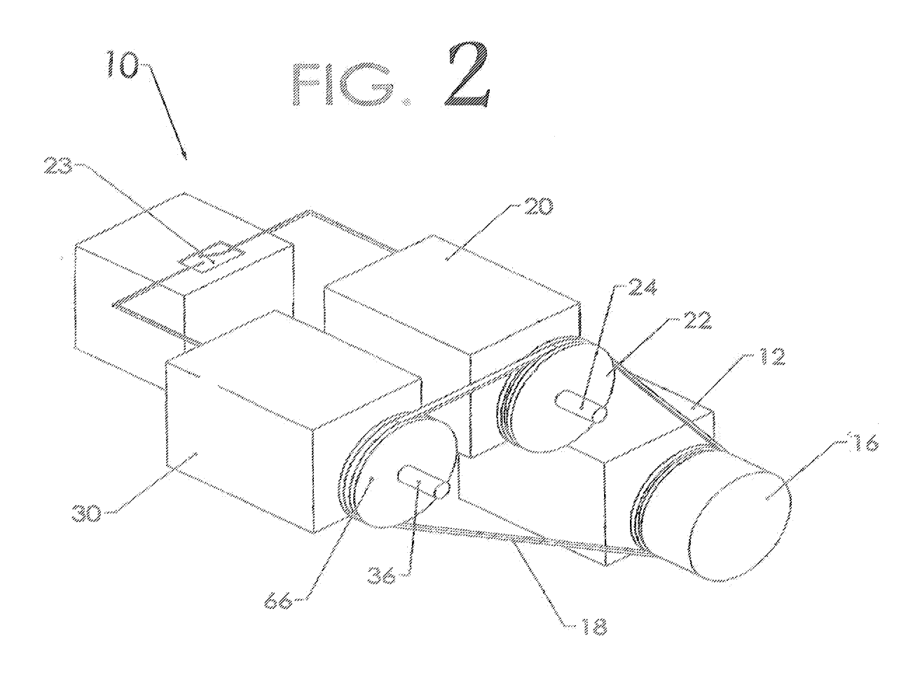

FIG. 2 shows a perspective and schematic drawing of the basic components of the system 10, according to the principles of the invention. The system 10 includes a primary source 12, an air conditioning compressor 20, and a motor generator 30. The air conditioning compressor pulley 22 is coupled to the air conditioning compressor shaft 24 extending from the air conditioning compressor 20; a motor generator pulley 66 is coupled to a motor generator shaft 36 extending from the motor generator 30. In like manner, a primary source shaft 114 extends from the primary source 12, and terminates in a drive housing 16 that includes a pulley portion (shown in greater detail aft).

Still referring to FIG. 2, activation of the primary source 12 imparts torque through the primary source shaft 114 to a belt 18 that engages the respective pulleys 22, 66, thereby transmitting a rotating torque from the primary source shaft 114 to each of the air conditioning compressor pulley 22 and the motor generator pulley 66. Thus, when the primary source 12 is activated, torque originates with the primary source shaft 114, which then drives the motor generator 30. When one desires to activate the air conditioning compressor 20 while operating the primary source 12 (i.e., while the engine is running), then the air conditioning compressor pulley 24 receives torque originated by the primary source 12 and imparted to the air conditioning compressor 20 through its shaft 24 that is turned by its pulley 22, which was rotated by torque transmitted through the belt 18. In contrast, when one does not desire air conditioning, a clutch mechanism is released, thereby allowing rotation of the air conditioning compressor shaft 24 relative its pulley 22.

Still referring to FIG. 2, the system 10 enables the air conditioning compressor pulley 24 (and therefore the air conditioning compressor shaft 22) to be turned by rotating torque originated by the motor generator 30. When the primary source 12 is deactivated (i.e., when the motor is shut off), the air conditioning compressor 20 can nonetheless be activated. In this mode, the air conditioning compressor may be driven by the motor generator 30. In this mode of operation, one activates the switch on the battery pack 23, which activates the motor generator 30 and imparts rotating torque to the motor generator pulley 66 via the motor generator shaft 36.

As shown in FIG. 2, the terminal end of the air conditioning compressor shaft 24 may extend from its respective air conditioning compressor pulley 22, and the terminal end of the motor generator shaft 36 may extend outwardly from its respective motor generator pulley 66. However, an auxiliary drive 16 encloses the terminus of the primary drive shaft 12. The component parts of the auxiliary drive 16 has a belt engaging portion and an elongate portion; the component parts within the auxiliary drive 16 enable rotation of the auxiliary drive 16 relative the primary source shaft 114, as discussed hereinafter.

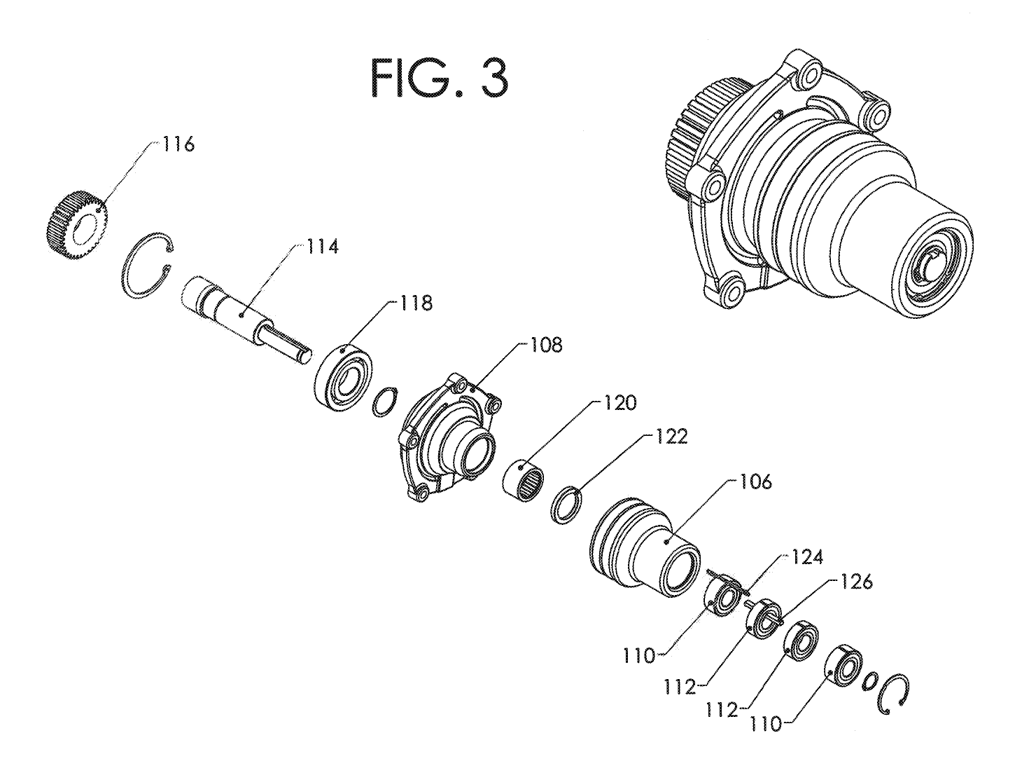

FIG. 3 shows an exploded and perspective view detailing the component parts of the invention. At a first end proximate the primary source shaft 114 (not viewable in FIG. 3 but see FIGS. 1, 2), the system includes a drive gear 116 cooperatively formed to mesh with a bull gear of the primary source 12 (not viewable in FIG. 3 but see FIGS. 1, 2). The drive gear 116 is coupled to an extension of the primary source shaft 114 and passes through a support bearing 118 that will be positioned around the shaft 114 and proximate the drive gear 116. The shaft 114 will also pass through a needle bearing 120, which will be positioned on the shaft 114 adjacent the support bearing 118.

Still referring to FIG. 3, the shaft 114, support bearing 118, and the needle bearing 120 will be at least partly covered by a housing 108, which in turn will be coupled or bolted to the primary source, the engine bracket, or another stable structure. Of course, the drive gear 116 is coupled to the shaft 114 so that rotation of the drive gear 116 is restricted relative the shaft 114. However, the shaft 114 rotates relative each of the support bearing 118 and the needle bearing 120 that will be positioned within the housing 108.

As shown in FIG. 3, the system will also include a sprag clutch mechanism 110, 112 coupled to a terminal end of the shaft 114. The shaft depicted in FIG. 3 shows a two-tiered configuration for the shaft 114, wherein the shaft has a reduced-diameter terminal portion that is distal the drive gear 116. Generally, this reduced-diameter terminal portion of the shaft 114 will extend beyond the housing 108 when fully assembled. However, the reduction of diameter portion is for illustration only, as the portion of the shaft 114 that extends outwardly from the housing 108 will receive the sprag clutch bearings 110, 112. To be clear, the shaft 114 may have a uniform diameter throughout its length. However, a reduced diameter portion is preferred in order to fit the inner race of standard sprag clutch bearings.

As shown in FIG. 3, the sprag clutch bearings 110, 112 have an inner race formed to engage the shaft 114, and the sprag clutch bearings 110, 112 bear an outer race formed to engage an interior wall of the primary source pulley 106. The inner race of each sprag clutch bearing 110, 112 bears a slot formed to receive an inner bearing key 126 that engages both the respective sprag clutch bearings 110, 112, but also engages a longitudinal slot formed on a terminal portion of the shaft 114. In like manner, the outer race of each sprag clutch bearing 110, 112 bears a slot formed to receive an outer bearing key 124 that will engage within a longitudinal slot formed on an interior surface of the primary source pulley 106. When fully assembled, the outer sprag bearing key 124 engages both the outer race of the sprag clutch bearings 110, 112 as well as a slot formed on the inner surface of the primary source pulley 106, thereby preventing rotation of the primary source pulley 106 relative the outer race of the sprag clutch bearings 110, 112. Conversely, when fully assembled the inner sprag bearing key 126 engages both the shaft 114 as well as the inner race of the sprag clutch bearings 110, 112, thereby preventing rotation of the shaft 114 relative the inner race of the sprag clutch bearings 110, 112.

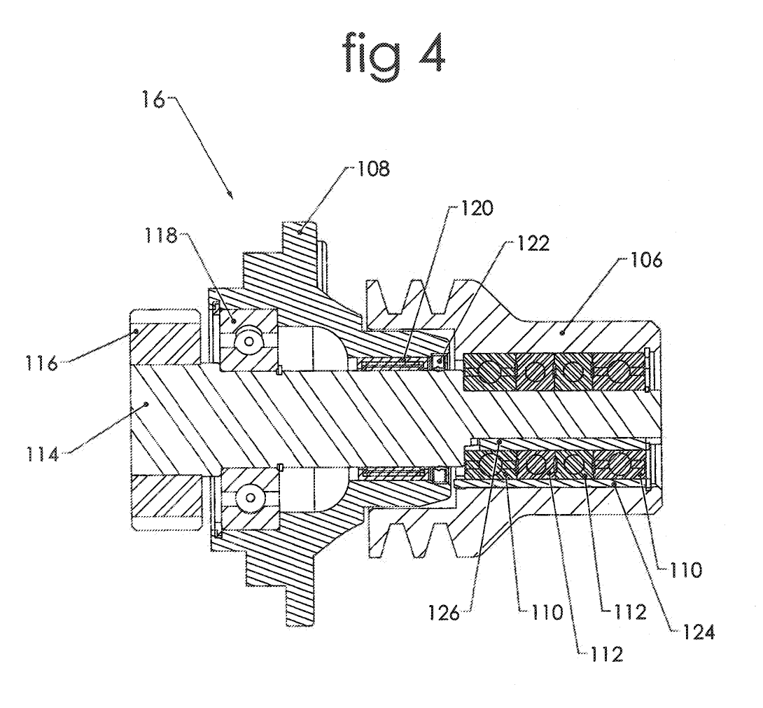

FIG. 4 shows a cross-sectional view of the component parts of the auxiliary drive assembly 16 that was generally depicted in FIGS. 1 and 2. The drive assembly 16 includes the primary source shaft 114 engaging a drive gear 116, passing through a housing 108, and also passing through a sprag clutch pulley 106. A support bearing 118 is positioned within the housing 108 and engages the primary source shaft 114, and of course allows rotation of the primary source shaft 114 relative the housing 108. The primary source shaft 114 passes from an entrance opening at one end of the housing 108 and out an exit opening at another end of the housing 108, and a portion extends beyond the housing 108. Sprag bearings 110, 112 are mounted on this portion of the primary source shaft 114 and engages within an interior of the elongate portion of the primary drive pulley 106. A typical sprag bearing has an inner race and an outer race, with relative rotation of the races being restricted to a single direction of rotation.

As shown in FIG. 4, the inner races of the sprag bearings 110, 112 are coupled to the primary source shaft 114 adjacent its terminal end, and the interior of the primary drive pulley 106 engages the outer race of the sprag bearings 110, 112. In this embodiment shown in FIG. 4, the primary source shaft 114 is configured with a reduced diameter portion adjacent its terminal end, and the sprag clutch 110, 112 engages on this reduced diameter portion.

When the primary source shaft 114 imparts driving torque (i.e., when the engine is running), the sprag bearings 110, 112 engage and prevent rotation of the primary source pulley 106 relative the primary source shaft 114. In contrast, when the engine is not running, the sprag bearings 110, 112 enable rotation of the primary source pulley 106 relative the shaft 114. Thus, with the engine off and the air conditioning compressor (shown hereinabove) driven by the motor generator 30, the sprag clutch 110, 112 allows the primary pulley 106 to freewheel relative the shaft 114.

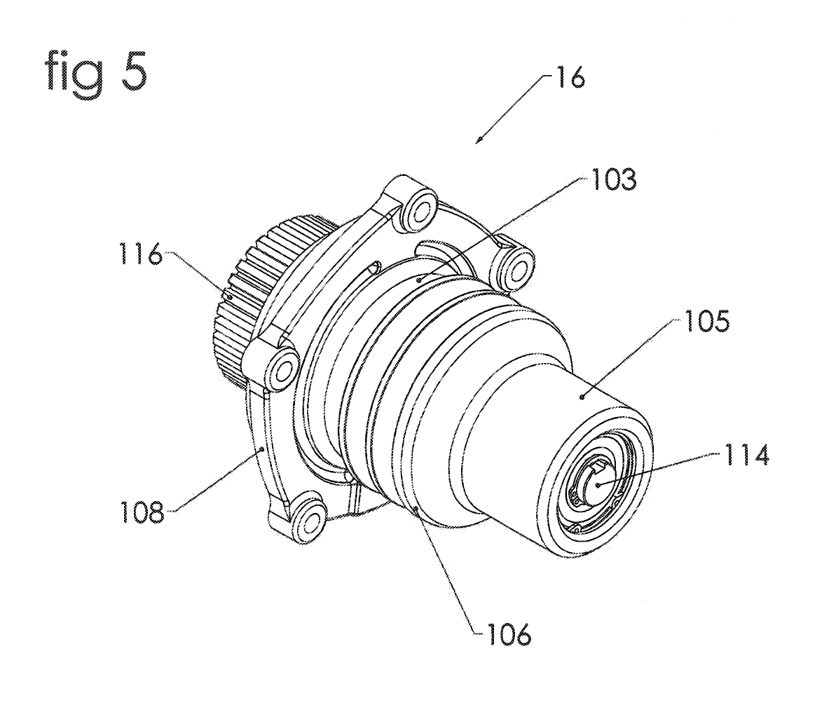

FIG. 5 shows an isolated and perspective view of the auxiliary drive 16 (See FIGS. 1, 2), shown in a fully-assembled condition. The auxiliary drive 16 bears a drive gear 116 positioned at an initial end. Preferably, this drive gear 116 is famed to mesh with a bull gear of a standard automobile or truck engine. A shaft 114 passes from the drive gear 116 through the housing 108, and terminates exterior the primary source pulley 106. As shown, the primary source pulley 106 bears a belt-engaging portion 103 and an elongate portion 105. The housing 108 is typically bolted to a frame portion of the automobile, and the primary source pulley 106 is formed to rotate about at least a portion of the housing 106.

Having described in detail the invention, it is to be understood that this description is for illustrative purposes only. The scope of the invention shall be limited only by claims which precisely set forth and metes and bounds of the invention.

We claim:

1. A system for operating an air conditioning compressor from alternative sources, the system comprising:
a primary drive pulley coupled to a primary drive shaft that extends from a primary source;
a sprag bearing having an inner race engaging the primary drive shaft and an outer race engaging the primary drive pulley, the sprag enabling rotation of the inner race relative the outer race in a single chosen direction of rotation;
a motor generator pulley coupled to a motor generator shaft that extends from a motor generator;
an air conditioning compressor pulley coupled to an air conditioning compressor shaft that extends from an air conditioning compressor;
a belt engaging each of the drive shaft pulley, the motor generator pulley, and the air conditioning compressor pulley; wherein,
the sprag bearing prevents rotation of the primary drive shaft relative the primary drive shaft pulley when torque is imparted through the primary drive shaft, and wherein,
the sprag bearing enables rotation of the primary drive shaft relative the primary drive shaft pulley when the primary drive pulley is rotated by torque transmitted to the primary drive pulley by the belt.

2. The system as in claim 1, the system further comprising
a drive housing adapted to allow the drive shaft to pass therethrough;
a reduced-diameter portion of the primary drive shaft positioned adjacent a terminal end of the primary drive shaft; wherein,
the sprag bearing is coupled to the reduced diameter portion of the primary drive shaft.

3. The system as in claim 2, wherein at least a portion of the reduced diameter portion extends outside the housing.

4. The system as in claim 2, further comprising a support bearing mounted to the primary drive shaft.

5. The system as in claim 3, wherein an inner portion of the support bearing engages the primary drive shaft and an outer portion of the support bearing engages within the drive housing.

6. The system as in claim 1, further comprising
a drive housing having an entrance opening and an exit opening, the drive housing adapted to allow the primary drive shaft to pass therethrough;
wherein a drive gear configured to mesh with a bull gear is positioned adjacent the entrance opening.

7. The system as in claim 6, further comprising
a portion of the primary drive shaft that extends outwardly from the exit opening of the drive housing; and wherein,
the inner race of the sprag bearing engages the portion of the primary drive shaft that extends outwardly from the exit opening of the drive housing.

8. The system as in claim 6, the primary drive pulley comprising a belt-engaging portion and an elongate portion; wherein, the outer race of the sprag bearing engages an interior of the elongate portion.

9. The system as in claim 6, the drive housing having a narrowed portion that is cooperatively formed to fit within and engage at least a portion of an interior of the primary drive pulley.

10. The system as in claim 1, further comprising
a switch to selectively activate the motor generator; and,
a clutch to selectively enable relative rotation of the air conditioning compressor shaft relative the air conditioning compressor pulley.

11. A method of operating an air conditioning compressor from alternative sources, the method including the steps of
providing a primary source, an air conditioning compressor, and a motor generator;
equipping the primary source with a primary drive pulley coupled to a primary drive shaft;
equipping the motor generator with a motor generator pulley coupled to a motor generator shaft;
equipping the air conditioning compressor with an air conditioning compressor pulley coupled to an air conditioning compressor shaft;
providing a sprag bearing having an inner race and an outer race, the sprag bearing enabling rotation of the inner race relative the outer race in a single chosen direction of rotation;
engaging the inner race to the primary drive shaft;
engaging the outer race to the primary drive pulley;
engaging a belt with each of the drive shaft pulley, the motor generator pulley, and the air conditioning compressor pulley;
configuring the sprag bearing to prevent rotation of the primary drive shaft relative the primary drive shaft pulley when torque is imparted through the primary drive shaft;
further configuring the sprag bearing to allow rotation of the primary drive shaft relative the primary drive shaft pulley when the primary drive pulley is rotated by torque transmitted to the primary drive pulley by the belt.

12. The method as in claim 11, the method further comprising the steps of
providing a drive housing adapted to allow the primary drive shaft to pass therethrough;
forming a reduced-diameter portion adjacent a terminus of the primary drive shaft; wherein,
coupling the sprag bearing to the reduced diameter portion of the primary drive shaft.

13. The method as in claim 12, wherein at least a portion of the primary drive shaft extends outside the drive housing.

14. The method as in claim 12, further comprising the step of mounting a support bearing to the primary drive shaft.

15. The method as in claim 14, further comprising the steps of engaging an inner portion of the support bearing with the primary drive shaft; and,
engaging an outer portion of the support bearing with the drive housing.

16. The method as in claim 12, further comprising the step of
passing the primary drive shaft into an entrance opening of the drive housing and out from an exit opening of the drive housing; and,
positioning a drive gear is adjacent the entrance opening, and, meshing the drive gear with a bull gear of a motor.

17. The method as in claim 16, further comprising
extending a portion of the primary drive shaft outwardly from the exit opening of the drive housing; and
engaging the inner race of the sprag bearing with the portion of the primary drive shaft that extends outwardly from the exit opening of the drive housing.

18. The method as in claim 17, the primary drive pulley comprising a belt-engaging portion and an elongate portion; wherein, the outer race of the sprag bearing engages an interior of the elongate portion.

19. The method as in claim 12, the drive housing having a narrowed portion that is cooperatively formed to fit within and engage at least a portion of an interior of the primary drive pulley.

20. The method as in claim 11, further comprising the steps of
deactivating the primary source; and,
activating the motor generator to impart a rotating torque to the motor generator shaft; and,
transmitting the rotating torque to the air conditioning compressor.
